(19) United States
(12) Patent Application Publication
(10) Pub. No.: US 2018/0107379 A1
(43) Pub. Date: Apr. 19, 2018

(54) TOUCH PANEL, TOUCH CONTROL DISPLAY DEVICE AND METHOD OF DRIVING THE SAME

(71) Applicants: BOE TECHNOLOGY GROUP CO., LTD., Beijing (CN); BEIJING BOE DISPLAY TECHNOLOGY CO., LTD., Beijing (CN)

(72) Inventors: Peng Jia, Beijing (CN); Baoqiang Wang, Beijing (CN); Sang Jin Park, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/521,237

(22) PCT Filed: Aug. 10, 2016
(86) PCT No.: PCT/CN2016/094372

§ 371 Date: Apr. 21, 2017

(30) Foreign Application Priority Data
Jan. 8, 2016 (CN) 201610009643.1

(51) Int. Cl. G06F 3/0488; G06F 3/044; G06F 3/041

(52) U.S. Cl. CPC G06F 3/04886; G06F 2203/04112; G06F 3/0416; G06F 3/044

(57) ABSTRACT

The present disclosure provides a touch panel, a touch control display device including the touch panel and a method of driving the touch panel enabling divisional or partition touch control scan. The touch panel includes an electrode array that is composed of a plurality of touch control drive electrodes and a plurality of touch control sensing electrodes and is divided into n touch control regions. Each touch control region includes at least one touch control drive electrode and at least one touch control sensing electrode, and the touch control drive electrodes and the touch control sensing electrodes are arranged to, during a touch control scan, a touch control scan signal is allowed to be individually provided to the touch control drive electrodes in each touch control region and sensing signals, caused by a touch action on the touch panel, are allowed to be received from the touch control sensing electrodes in each touch control region, so as to determine a position of the touch action on the touch panel.

### CROSS-REFERENCE TO RELATED APPLICATIONS

This application is a Section 371 National Stage Application of International Application No. PCT/CN2016/094372, filed on Aug. 10, 2016, entitled “TOUCH PANEL, TOUCH CONTROL DISPLAY DEVICE AND METHOD OF DRIVING THE SAME”, which claims priority to Chinese Application No. 201610009643.1, filed on Jan. 8, 2016, incorporated herein by reference in their entirety.

### BACKGROUND

### 1. Technical Field

Embodiments of the present disclosure generally relate to touch control display technical field, and particularly to a touch panel capable of achieving partition touch control scan and a method of driving the same, a touch control display device including the touch panel.

### 2. Description of the Related Art

Recently, touch control technology is widely applied in various electronic products. A touch panel may be classified as a resistance type and a capacitance type according to its principle of operation. Currently, a capacitance type touch panel is increasingly popularized in electronic products. A capacitance type touch panel works by using an electrical current induced by a human body and is a touch panel, in which a touch signal is sensed by combining electrodes and the human body. Specifically, when the human body (such as a finger) touches the panel, a coupling capacitor is formed, due to electrical field of the human body, between the finger and a conductive layer of the touch panel such that an electrical current conducted on electrodes of the touch panel will flow to the touch point so that a position of the touch point can be accurately calculated.

Currently, in a touch panel, such as, an in cell touch panel having touch control drive electrodes Tx and touch control sensing electrodes Rx, during a touch control scan, a touch control scanning signal is inputted to one drive electrode Tx and sensing signals are received from all sensing electrodes Rx at a time. By this way, the touch control scan is performed for each of the drive electrodes Tx. However, in a large size touch panel, as the electrodes are increased number and resolution of the panel is increased, the time for scanning the drive electrodes Tx in sequence increases and, under condition where the fresh frequency is maintained to be constant, the rest time for display is reduced and pixels are insufficient to be charged.

### SUMMARY

In order to overcome at least one of the above and other problems and defects in prior arts, the present invention is provided.

According to an aspect of the present disclosure, there is provided a touch panel, comprising an electrode array that is composed of a plurality of touch control drive electrodes and a plurality of touch control sensing electrodes, wherein the touch panel is divided into n touch control regions, where n is a integer greater than or equal to 2, each of the touch control regions comprising at least one of the touch control drive electrodes and at least one of the touch control sensing electrodes, and the plurality of touch control drive electrodes and the plurality of touch control sensing electrodes are arranged such that the touch control drive electrodes in each of the touch control regions are allowed to be individually provided a touch control scan signal during a touch control scan, and sensing signals, which are caused by a touch action on the touch panel, are allowed to be individually received from the touch control sensing electrodes in each of the touch control region, so as to determine a position of the touch action on the touch panel.

In one embodiment, the touch panel is driven by a control circuit to perform the touch control scan, and the touch control sensing electrodes in each of the touch control regions are electrically connected to the control circuit, independently of the touch control sensing electrodes in the others of the touch control regions.

In one embodiment, each of the touch control regions comprises a plurality of columns of touch control drive electrodes, and each column of touch control drive electrodes in each of the touch control regions are electrically connected to the control circuit, independently of the others columns of touch control drive electrodes in the touch control region.

In one embodiment, the touch panel further comprises a plurality of sensing electrode leading wire, wherein the touch panel is divided into n touch control regions in a row direction of the electrode array, each of the touch control sensing electrodes is a plate electrode, in each of the touch control regions, m columns of touch control drive electrodes and a p×m electrode plate sub-array composed of p rows of touch control sensing electrodes and m columns of touch control sensing electrode are comprised, where m and p are each integer greater than or equal to 1, and each row of touch control sensing electrodes in each of the touch control regions are electrically connected to a same sensing electrode leading wire.

In one embodiment, the touch panel further includes common electrodes and the plurality of touch control sensing electrodes, as a whole, form at least a portion of the common electrodes.

In one embodiment, each of the touch control drive electrodes is a strip electrode or a plate electrode, which extends a length in a column direction of the electrode array, and touch control sensing electrodes in a corresponding column that are located adjacent to the strip electrode or the plate electrode are spaced apart from each other and arranged within a range of the length.

In one embodiment, in each of the touch control regions, orthographic projections of m columns of touch control drive electrodes and m columns of touch control sensing electrode on a surface of the touch panel are alternately arranged and arrayed in the row direction of the electrode array.

In one embodiment, in each of the touch control regions, each column of touch control drive electrodes are located adjacent to only one column of touch control sensing electrodes in the row direction of the electrode array.

In one embodiment, the touch panel may further include a plurality of drive electrode leading wires, wherein, the touch panel is divided into n touch control regions in a row direction of the electrode array, each of the touch control drive electrodes is a plate electrode, each of the touch control regions comprises a column of p touch control sensing electrodes and a p×m electrode plate sub-array composed of p columns of touch control drive electrodes and m columns of touch control drive electrodes, where m and p are respectively integer greater than or equal to 1, and each column of touch control drive electrode plates in each of the touch control regions are electrically connected to a same drive electrode leading wire.

In one embodiment, the touch panel comprises common electrodes and the plurality of touch control drive electrodes, as a whole, form at least a portion of the common electrodes.

In one embodiment, in each of the touch control regions, each touch control sensing electrode extends a length in the row direction of the electrode array and touch control drive electrodes in a row located adjacent to the touch control sensing electrode, are spaced apart from each other and arranged within a range of the length.

In one embodiment, in each of the touch control regions, orthographic projections of the p touch control sensing electrodes and p columns of touch control drive electrode plates on a surface of the touch panel are arranged alternately in the column direction of the electrode array.

In one embodiment, in each of the touch control regions, each of the touch control drive electrodes is located adjacent to only one row of touch control sensing electrodes in the column direction of the electrode array.

In one embodiment, the touch panel may further include two substrates opposite to each other and the plurality of touch control drive electrodes and the plurality of touch control sensing electrodes are located on at least one of the two substrates.

In one embodiment, the plurality of touch control drive electrodes are located a substrate that is the same as or different from the substrate where the plurality of touch control sensing electrodes are located.

In one embodiment, the plurality of touch control drive electrodes and the plurality of touch control sensing electrodes are located in a same layer or different layers of the same substrate.

In one embodiment, one of the two substrates is a thin film transistor substrate and the other is a color film substrate.

According to an aspect of the present disclosure, there is provided a touch control display device including any one of the above touch panels.

According to another aspect of the present disclosure, there is provided a method of driving the above touch panel, the method comprising:

during a touch control scan, simultaneously providing a touch control signal to one touch control drive electrode or one column of touch control drive electrode(s) and receiving sensing signals, caused by a touch action on the touch panel, from all the touch control sensing electrodes, so as to determine a position of the touch action on the touch panel.

In one embodiment, in each of the touch control regions, m columns of touch control drive electrodes are respectively numbered as a first column to a m^{th} column of touch control drive electrodes, and n columns of touch control drive electrodes, with the same column number, in n touch control regions compose one group of touch control drive electrodes, thereby the touch panel including m groups of touch control drive electrodes, and during the touch control scan, the method comprises the following steps of:

S1: simultaneously applying the touch control scanning signal to all n columns of touch control drive electrodes in one group of touch control drive electrodes and receiving the sensing signals from all the touch control sensing electrodes; and

S2: repeating step S1 in sequence for each of the m groups of touch control drive electrodes until the touch control scanning operation has been performed for all the m groups of touch control drive electrodes.

Other objects and advantages of the present disclosure will be obvious and comprehensive understanding of the disclosure may be assisted to obtained by the following description of the present invention by reference of the drawings.

### BRIEF DESCRIPTION OF THE DRAWINGS

Features and advantages of the present disclosure may be more clearly understood by reference to drawings. The drawings are illustrative, but not understood to apply any limitation to the present invention; in drawings:

FIG. 1 is a schematic view illustrating an arrangement of an electrode array pattern of a touch panel according to an exemplary embodiment of the present disclosure;

FIG. 2 is a schematic view illustrating an arrangement of an electrode array pattern of a touch panel according to another exemplary embodiment of the present disclosure; and

FIG. 3 is a schematic flow chart of a method of driving a display device including a touch panel according to an exemplary embodiment of the present disclosure.

### DETAILED DESCRIPTION OF PREFERRED EMBODIMENTS

Embodiments of the present disclosure are described in detailed in conjunction with the drawings. In the description, same or similar components are denoted by same or similar reference number. The following description of the embodiments of the present disclosure by reference to the drawings is intended to illustrate a general concept of the present invention, but not understood to limit the present invention.

In addition, in the following description, for convenient of illustration, much detailed description will be made so as to completely understand the embodiments of the present disclosure. However, it is obvious one or more embodiments may be implemented without the detailed description. In other situation, known structure and device are shown in schematic way to simplify the drawings.

According to a general concept of the present invention, there is provided a touch panel including an electrode array that is composed of a plurality of touch control drive electrodes and a plurality of touch control sensing electrodes, the touch panel is divided into a plurality of touch control regions and each of the touch control regions comprises at least one touch control drive electrode and at least one touch control sensing electrode, and the plurality of touch control drive electrodes and the plurality of touch control sensing electrodes are arranged such that a touch control scan operation may be performed simultaneously in the touch control regions so as to reduce time for the touch control scan on the entire panel by compared to the situation where respective drive electrodes of the panel is scanned in sequence.

An embodiment of the disclosure provides a touch panel including an electrode array that is composed of a plurality of touch control drive electrodes and a plurality of touch control sensing electrodes,

the touch panel is divided into n touch control regions, where n is a integer greater than or equal to 2, each of the touch control regions comprises at least one touch control drive electrode and at least one touch control sensing electrode, and

the plurality of touch control drive electrodes and the plurality of touch control sensing electrodes are arranged such that, during a touch control scan, a touch control scan signal can be individually provided to the touch control drive electrodes in each of the touch control regions and sensing signals, which are caused by a touch action on the touch panel, can be individually received from the touch control sensing electrodes in each of the touch control regions, so that a position of the touch action on the touch panel can be determined.

Exemplarily, in the touch panel provided by the present disclosure, during the touch control scan, the touch control scan signal may be individually provided to the touch control drive electrodes in each of the touch control regions and the sensing signals, caused by the touch action on the touch panel, may be received from the touch control sensing electrodes in the touch control region independently of other touch control regions so that the position of the touch action on the touch panel is determined. As the touch panel of the present disclosure is divided into a plurality of divisional regions and the divisional regions may be simultaneously scanned such that a total touch control scan time for the divisional regions is reduced, and more time is remained as display time under condition where the refresh frequency is maintained to be constant and thus it ensures in a high-resolution panel, sufficient charging time may be provided to charge the pixels.

FIG. 1 schematically illustrates an arrangement of an electrode pattern of a touch panel according to an exemplary embodiment of the present disclosure. As shown in FIG. 1, the touch panel includes an electrode array formed by a plurality of touch control drive electrodes Tx (denoted by Txn_m, such as Tx1_1, Tx1_2 . . . , Tx2_1, Tx2_2 . . . , Txn-1_1, Txn-1_2 . . . , Txn_1, Txn_2 . . . ) and a plurality of touch control sensing electrodes Rx, and a plurality of sensing electrode leading wires Rn_p (such as R1_1, R2_1 . . . , R1_2, R2_2 . . . , Rn_1, R(n-1)_1 . . . , Rn_2, R(n-1)_2 . . . ). The touch panel is divided into n touch control regions (as defined by dashed line) in a row direction of the electrode array, including a 1^{st} region, a 2^{nd} region 2, . . . , a (n-1)^{th} region and a n^{th} region, and each of the touch control regions includes m columns of touch control drive electrodes Tx and a p×m sub-array including p rows of touch control sensing electrodes and m columns of touch control sensing electrodes, and, each row of the touch control sensing electrodes Rx in each of the touch control region are in electrical connection with a same sensing electrode leading wire, where n is an integer greater than or equal to 2, m and p are respectively integer greater than or equal to 1, for example, m and/or p are respectively integer greater than or equal to 2. For example, Txn_m represents the m^{th} column of touch control drive electrode in the n^{th} region, and Rn_p represents the sensing electrode leading wire that is in electrical connection with a the p^{th} row of touch control sensing electrode in the n^{th} region.

In the embodiment, each of the touch control regions includes a p×m sensing electrode array, m touch control sensing electrodes in each row in each of the touch control regions are in electrical connection with the same sensing electrode leading wire, p rows of the touch control sensing electrodes in each of the touch control regions are in electrical connection with different sensing electrode leading wires, and respective rows of the touch control sensing electrodes in respective touch control regions are in electrical connection with different sensing electrode leading wires, such that the touch control sensing electrodes in each of the touch control regions are enabled to be in electrical connection with, through corresponding electrodes leading wire, a control circuit (not shown) for driving the touch panel, such as a touch control reconnaissance and measurement chip, independently of the touch control sensing electrodes in other touch control regions. In addition, each touch control region may include a plurality of touch control drive electrodes or a plurality of columns of touch control drive electrodes and each touch control drive electrode or each column of touch control drive electrodes may be in electrical connection with the control circuit independently to other touch control drive electrodes in the touch control region.

Thus, in the embodiment, compared to a situation where, in a conventional panel, each sensing electrode leading wire is electrically connected to one of the touch control sensing electrodes in a row of touch control sensing electrodes in a whole panel, each of the sensing electrode leading wires is merely electrically connected to a single row of touch control sensing electrodes in a single touch control region, such that touch control scanning operations can be simultaneously performed in n touch region regions, that is, touch control scanning signals may be simultaneously provided to one touch control drive electrode or a column of touch control drive electrodes in a single touch control region and sensing signals may be received respectively from all the touch control sensing electrodes, thereby achieving a divisional or partition scan of the touch panel.

It is understood that, in the embodiment, each row or each column of the touch control drive electrodes in each of the touch control regions may be individually in electrical connection with the control circuit through different drive electrode leading wires (not shown), or, touch control drive electrodes with a same column number in each of the touch control regions may be in electrical connection with the control circuit through a same drive electrode leading wire. In other words, each column of the touch control drive electrodes in each touch control region is in electrical connection with the control circuit independently of the other columns of touch control drive electrodes in the touch control region. However, the disclosure is not limited to this, as long as a touch control scanning signal may be simultaneously provided to one touch control drive electrode or one column of touch control drive electrodes in each touch control region during a touch control scan, i.e., there is one touch control drive electrode or one column of touch control drive electrodes in each of the touch control regions to be provided with the touch control scanning signal during a same scan cycle.

In the embodiments shown in Figures, each of the touch control sensing electrodes Rx may be a plate electrode, such as in a rectangle shape, a round shape, an elliptical shape or other polygon shape. In an exemplary embodiment, all the touch control sensing electrodes, as a whole, may form at least a portion of common electrodes of the touch panel. In this situation, during display of the touch panel, a same voltage may be applied to all the touch control sensing electrodes such that the whole of the touch control sensing electrodes may double or also act as the common electrode; while during touch control scan of the touch panel, the above divisional or partition scanning operation may be performed. In the situation where the touch control sensing electrodes doubles or also act as the common electrodes, each of the touch control sensing electrodes may be a transparent plate electrode or a light-transmission mesh electrode, and a plate electrode (not shown) that forms a portion of the common electrode may be provided within a gap between adjacent ones of the touch control sensing electrodes.

As shown in FIG. 1, the touch control drive electrodes Tx may be each in a strip shape or a plate shape, and extend in a column direction of the electrode array. For example, the strip-shaped or plate-shaped electrodes each extend by a length in the column direction of the electrode array, and touch control sensing electrodes Rx in a corresponding column adjacent to each touch control drive electrode or each column of touch control drive electrodes Tx are arranged within the range of the length, by which the touch control drive electrode extends in the column direction of the electrode array, and spaced apart from each other .That is, one touch control drive electrode Tx and a plurality of (such as, p) touch control sensing electrodes Rx, which are arranged in a column adjacent to the touch control drive electrode Tx, form mutual capacitor(s). Alternatively, each of the touch control drive electrodes may include a plurality of plate electrodes that are arrayed in a column and are in electrical connection with one another.

In FIG. 1, m columns of touch control drive electrodes Tx and m columns of touch control sensing electrodes Rx in each of the touch control regions are alternately arranged and spaced away from each other. In other words, orthographic projections of the m columns of touch control drive electrodes and the m columns of touch control sensing electrodes in each of the touch control regions on a surface of the touch panel (for example, a surface of a base substrate of the touch panel) are alternately arranged and spaced away from each other in the row direction of the electrode array, for example, the electrodes are arranged in a sequence of Tx, Rx, Tx, Rx in the row direction. In an alternative embodiment, in each of the touch control regions, each column of the touch control drive electrodes is located adjacent to only one column of the touch control sensing electrodes in the row direction. For example, the electrodes are arranged in a sequence of Tx, Rx, Rx, Tx, Tx, Rx, Rx, Tx, Tx, Rx in the row direction, so that a position of touch point or touch action on the touch panel may be more accurately determined.

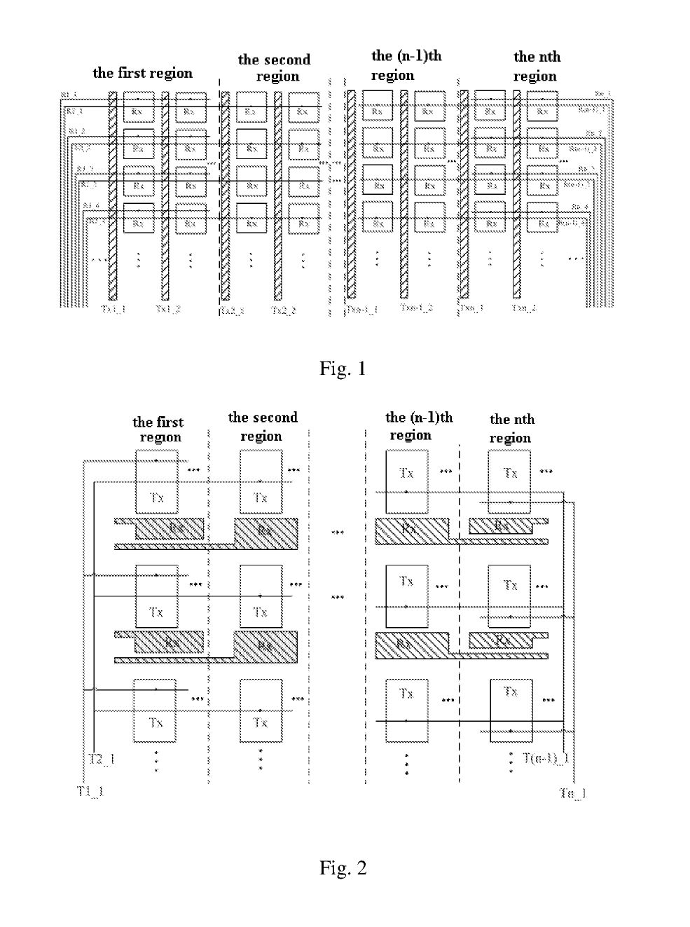

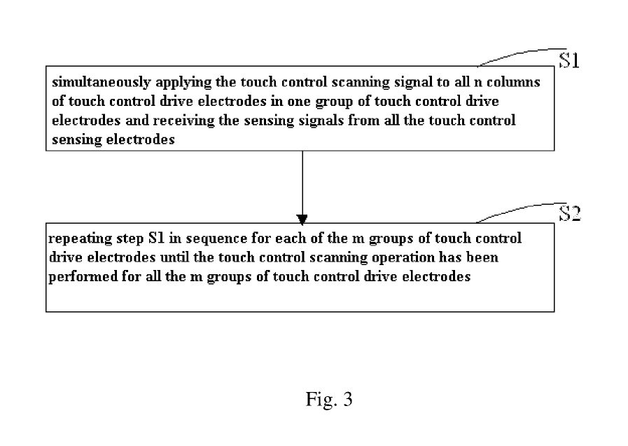

FIG. 2 schematically illustrates an arrangement of an electrode pattern of a touch panel according to another embodiment of the present disclosure. As shown in the Figure, the touch panel includes an electrode array composed of a plurality of touch control drive electrodes Tx and a plurality of touch control sensing electrodes Rx and a plurality of drive electrode leading wire Tn_m (for example, T1_1, T1_2, . . . , T2_1, T2_2 . . . , T(n-1)_1 . . . , Tn_1 . . . ) The touch panel is divided into n touch control regions (as shown by the dashed line), including a first region, a second region, . . . , a (n-1)^{th} and a n^{th} region. Each of the touch control regions includes a column of p touch control sensing electrodes and a p×m sub-array composed of p rows of touch control drive electrodes and m columns of touch control drive electrodes. Each column of touch control drive electrode block in each of the touch control regions is electrically connected to a same drive electrode leading wire. Each column of touch control drive electrodes in each of the touch control regions are electrically connected, independently of the other columns of touch control drive electrodes in the touch control region, to a control circuit (not shown), such as a touch control reconnaissance and measurement chip, which is configured to drive the touch panel, through a corresponding drive electrode leading wire. In the embodiment, n is an integer greater than or equal to 2, m and p are respectively an integer greater than or equal to 1, for example m and/or p are respectively an integer greater than or equal to 2, and Tn_m represents the electrode leading wire, which is electrically connected to the m^{th} column of touch control drive electrodes in the n^{th} region.

In the embodiment, each of the touch control regions includes a p×m array of the drive electrodes. In each of the touch control regions, each column of p touch control drive electrodes are electrically connected to a same drive electrode leading wire and m columns of touch control sensing electrodes are electrically connected to different drive electrode leading wires, and the touch control sensing electrodes in all the touch control regions are all electrically connected to the control circuit through different sensing electrode leading wires (no shown).

With this configuration in the embodiment, compared to the situation in a conventional panel where the sensing electrode leading wires are all electrically connected to one of the touch control sensing electrodes in a row of the touch control sensing electrodes in the entire panel, in the embodiment, each sensing electrode leading wire is electrically connected to one touch control sensing electrode in only one touch control region and each drive electrode leading wire is electrically connected to one column of touch control sensing electrodes in one touch control region, such that touch scanning operation may be simultaneously performed in n touch control regions, that is, a touch control scanning signal are simultaneously provided to a column of touch control drive electrodes of each of the touch control regions and sensing signals are received from all the touch control sensing electrodes, thereby achieving a divisional or partition scan of the touch panel.

It is understood that, in the embodiment, each column of touch control drive electrodes of each touch control region may be individually in electrical connection with the control circuit through different drive electrode leading wires (no shown), or, the touch control drive electrodes in the columns with the same number in all the touch control regions may be in electrical connection with the control circuit through a same drive electrode leading wire. However, the present disclosure is not limited to this, as long as the touch control scanning signal may be simultaneously provided to a column of touch control drive electrodes in all the touch control regions during touch control scan, that is, one column of touch control drive electrodes of all the touch control regions may be provided with the touch control scanning signal during a same scan cycle.

In the embodiment shown in FIG. 2, each touch control drive electrode Rx may be a plate electrode, such as in a rectangle shape, a circle shape, an elliptical shape or in other polygon shape. In an exemplary embodiment, all the touch control drive electrodes, as a whole, may form at least a part of a common electrode of the touch panel. In this situation, during a display operation of the touch panel, a voltage may be applied to all the touch control drive electrodes such that all the touch control drive electrodes may double or also act, as a whole, as the common electrode, while during a touch control operation of the touch panel, the above divisional or partition scanning operation may be performed. In the situation where all the touch control drive electrodes may be used double or also act as the common electrode, each of the touch control drive electrodes may be a transparent plate electrode or a light-transmission mesh electrode, and a plate electrode (not shown) that forms a portion of the common electrode may be provided within a gap between adjacent touch control drive electrodes.

As shown in FIG. 2, each touch control sensing electrode Rx may be a strip shaped or a plate-shaped electrode, extend in the row direction of the electrode array, and have an elongated extension portion that is electrically connected to the sensing electrode leading wire (not shown). Further, touch control drive electrodes Tx in a corresponding row which is located adjacent to each touch control sensing electrode Rx in the column direction, are spaced apart from each other and arranged within a length range, within which the each touch control sensing electrode extends in the row direction of the electrode array, that is, one touch control sensing electrode Rx and a plurality of (such as, m) adjacent touch control drive electrodes Tx that are arranged into a row, form mutual capacitor(s). Alternatively, each touch control sensing electrode may include a plurality of plate electrodes that are arranged into a row and electrically connected to each other.

In FIG. 2, p rows of touch control drive electrodes Tx and p touch control sensing electrodes Rx in each touch control region are spaced apart from each other and arranged alternately, that is, the orthographic projections of the p rows of touch control drive electrodes Tx and the p touch control sensing electrodes Rx in each touch control region on a plane, which is parallel to a surface (for example, a surface of substrate which is parallel to the touch panel and on which the electrodes are arranged) of the touch panel, are alternately arranged in the column direction of the electrode array. For example, the electrodes are arranged in a sequence of Tx, Rx, Tx, Rx in the column direction. Although the elongated extension portion of the touch control sensing electrode Rx in the embodiment as shown in FIG. 2 extends between the touch control sensing electrode Rx and the touch control drive electrode Tx of two adjacent touch control regions, the elongated extension portion may be configured to apply very small or ignorable influence on the mutual capacitor between the touch control drive electrode Tx and m columns of touch control sensing electrode Rx. In another example, the elongated portion may be replaced by a leading wire, or strides over its adjacent touch control sensing electrodes and located above or below the adjacent touch control sensing electrodes, just as shown in FIG. 1. In an alternative embodiment, in each touch control region, each row of touch control drive electrodes are located adjacent to one touch control sensing electrode in the column direction of the electrode array, for example, the electrodes are arranged in a sequence of Tx, Rx, Rx, Tx, Tx, Rx, Rx, Tx, Tx, Rx in the column direction, so that the position of touch action or touch point on the touch panel can be more accurately determined.

The touch panel in the above embodiment may include two substrates that are opposite to each other. For example, one substrate is a thin film transistor substrate and the other is a color film substrate, and the touch control drive electrodes and the touch control sensing electrodes are formed on at least one of the two substrates. For example, the touch control drive electrodes may be formed on the same substrate as the touch control sensing electrodes, or the touch control drive electrodes may be formed on the substrate different from that on which the touch control sensing electrodes are formed. Exemplarily, the touch control drive electrodes and the touch control sensing electrodes may be formed in the same layer or different layers on the same substrate.

According to a still exemplary embodiment of the present disclosure, there is provided a touch display device including the above touch panel. The touch panel may be an in cell touch panel. The display device may include a mobile phone, a notebook computer, a tablet computer, a display, a digital photo frame, a navigator, an identity identifying apparatus or any one of products or components that have a display function.

According to a further exemplary embodiment of the present disclosure, there is provided a method of driving the touch panel provided according to the above embodiments, including: during touch control scanning, providing a touch control scanning signal simultaneously to one touch control drive electrode or one column of touch control drive electrodes in each touch control region and receiving sensing signals, caused by a touch action on the touch panel, from all touch control sensing electrodes, so as to determine a position of the touch action on the touch panel.

For the embodiments of the touch panel as shown in FIGS. 1 and 2, m columns of touch control drive electrodes in each touch control region may be numbered as a first column to a m^{th} column of touch control drive electrodes, and n columns of touch control drive electrodes, with the same column number, in the n touch control regions compose a group of touch control drive electrodes, thereby the touch panel includes m groups of touch control drive electrodes. In this instance, as shown in FIG. 3, during touch control scanning, the driving method includes the following steps:

S1: simultaneously applying a touch control scanning signal to all n columns of touch control drive electrodes in one group of touch control drive electrodes and receiving sensing signals from sensing electrode leading wires that are electrically connected to the touch control sensing electrodes; and

S2: repeating step S1 in sequence for each of the m groups of touch control drive electrodes until the touch control scanning operation has been performed for all the m groups of touch control drive electrodes.

For example, during touch control scanning, a scan signal is provided to a first column of touch control drive electrodes of respective touch control regions, and sensing signals are received from all the touch control sensing electrodes. Then, a scan signal is provided to a second column of touch control drive electrodes of respective touch control regions, and sensing signals are received from all the touch control sensing electrodes. In turn, the touch control scan is repeated for the third, the fourth, . . . the m^{th} column of touch control drive electrodes in respective touch control regions so as to achieve divisional or partition scan, reducing a total touch control scan time for the entire panel. Thus, under a situation where the refresh frequency is maintained to be constant, more time may be saved for display such that sufficient charging time for pixels may be ensured in a high-resolution panel. It is understood that n columns of touch control drive electrodes in the same group of touch control drive electrodes may be numbered in similar way or different way for respective touch control regions.

Although in the above embodiment, the touch panel is divided into n touch control regions in the row direction for implementing divisional or partition scan, it is understood that the touch panel may be also divided into n touch control regions in the column direction for implementing divisional or partition scan, or may be, in both row direction and column direction, divided into a plurality of touch control regions that are controllable individually, and divisional or partition scan for the touch panel may be also achieved in a similar way, which is not repeatedly described herein.

Although embodiments of the present disclosure have been illustrated and described, it is understood by those skilled in the art modifications and changes may be made on the embodiments within the spirit and scope of the present disclosure. The scope of the present invention may be defined by the attached claims and their equivalent.

1. A touch panel, comprising an electrode array that is composed of a plurality of touch control drive electrodes and a plurality of touch control sensing electrodes, wherein
the touch panel is divided into n touch control regions, where n is an integer greater than or equal to 2, each of the touch control regions comprising at least one of the touch control drive electrodes and at least one of the touch control sensing electrodes, and
the plurality of touch control drive electrodes and the plurality of touch control sensing electrodes are arranged such that the touch control drive electrodes in each of the touch control regions are allowed to be individually provided a touch control scan signal during a touch control scan, and sensing signals, which are caused by a touch action on the touch panel, are allowed to be individually received from the touch control sensing electrodes in each of the touch control regions, so as to determine a position of the touch action on the touch panel.

2. The touch panel according to claim 1, wherein the touch panel is driven by a control circuit to perform the touch control scan, and
the touch control sensing electrodes in each of the touch control regions are electrically connected to the control circuit, independently of the touch control sensing electrodes in others of the touch control regions.

3. The touch panel according to claim 2, wherein each of the touch control regions comprises a plurality of columns of touch control drive electrodes, and
each column of touch control drive electrodes in each of the touch control regions is electrically connected to the control circuit, independently of other columns of touch control drive electrodes in the touch control region.

4. The touch panel according to claim 1, further comprising a plurality of sensing electrode leading wire, wherein
the touch panel is divided into the n touch control regions in a row direction of the electrode array,
each of the touch control sensing electrodes is a plate electrode,
each of the touch control regions comprises m columns of touch control drive electrodes and a p×m electrode plate sub-array composed of p rows of touch control sensing electrodes and m columns of touch control sensing electrodes, where m and p are each an integer greater than or equal to 1, and
each row of touch control sensing electrodes in each of the touch control regions is electrically connected to a same sensing electrode leading wire.

5. The touch panel according to claim 4, wherein the touch panel comprises common electrodes and the plurality of touch control sensing electrodes, as a whole, form at least a portion of the common electrodes.

6. The touch panel according to claim 4, wherein each of the touch control drive electrodes is a strip electrode or a plate electrode, which extends a length in a column direction of the electrode array, and touch control sensing electrodes in a corresponding column that are located adjacent to the strip electrode or the plate electrode are spaced apart from each other and arranged within a range of the length.

7. The touch panel according to claim 4, wherein in each of the touch control regions, orthographic projections of m columns of touch control drive electrodes and m columns of touch control sensing electrodes on a surface of the touch panel are alternately arranged and arrayed in the row direction of the electrode array.

8. The touch panel according to claim 4, wherein in each of the touch control regions, each column of touch control drive electrodes is located adjacent to only one column of touch control sensing electrodes in the row direction of the electrode array.

9. The touch panel according to claim 1, further comprising a plurality of drive electrode leading wires, wherein,
the touch panel is divided into the n touch control regions in a row direction of the electrode array,
each of the touch control drive electrodes is a plate electrode,
each of the touch control regions comprises a column of p touch control sensing electrodes and a p×m electrode plate sub-array composed of p columns of touch control drive electrodes and m columns of touch control drive electrodes, where m and p are each an integer greater than or equal to 1, and
each column of touch control drive electrode plates in each of the touch control regions are is electrically connected to a same drive electrode leading wire.

10. The touch panel according to claim 9, wherein the touch panel comprises common electrodes and the plurality of touch control drive electrodes as a whole compose at least a portion of the common electrodes.

11. The touch panel according to claim 9, wherein in each of the touch control regions, each touch control sensing electrode extends a length in the row direction of the electrode array and touch control drive electrodes in a row located adjacent to the touch control sensing electrode are spaced apart from each other and arranged within a range of the length.

12. The touch panel according to claim 9, wherein in each of the touch control regions, orthographic projections of the p touch control sensing electrodes and p columns of touch control drive electrodes on a surface of the touch panel are arranged alternately in the column direction of the electrode array.

13. The touch panel according to claim 9, wherein in each of the touch control regions, each of the touch control drive electrodes is located adjacent to only one row of touch control sensing electrodes in the column direction of the electrode array.

14. The touch panel according to claim 1, wherein the touch panel comprises two substrates opposite to each other and the plurality of touch control drive electrodes and the plurality of touch control sensing electrodes are located on at least one of the two substrates.

15. The touch panel according to claim 14, wherein the plurality of touch control drive electrodes are located on a substrate that is the same as or different from the substrate where the plurality of touch control sensing electrodes are located.

16. The touch panel according to claim 15, wherein the plurality of touch control drive electrodes and the plurality of touch control sensing electrodes are located in a same layer or different layers of the same substrate.

17. The touch panel according to claim 14, wherein one of the two substrates is a thin film transistor substrate and the other is a color film substrate.

18. A touch control display device comprising the touch panel according to claim 1.

19. A method of driving the touch panel according to claim 1, the method comprising:
during a touch control scan, simultaneously providing a touch control signal to one touch control drive electrode or one column of touch control drive electrode(s) and receiving sensing signals, caused by a touch action on the touch panel, from all the touch control sensing electrodes, so as to determine a position of the touch action on the touch panel.

20. A method of driving the touch panel according to claim 4, the touch panel comprising, in each of the touch control regions, m columns of touch control drive electrodes respectively numbered as a first column to a m^{th} column of touch control drive electrodes, and n columns of touch control drive electrodes, with the same column number, in n touch control regions making up one group of touch control drive electrodes, so that the touch panel includes m groups of touch control drive electrodes, wherein the method comprises:
during a touch control scan, simultaneously providing a touch control signal to one touch control drive electrode or one column of touch control drive electrode(s) and receiving sensing signals, caused by a touch action on the touch panel, from all the touch control sensing electrodes, so as to determine a position of the touch action on the touch panel; and
during the touch control scan, the method further comprises the following steps of:
S1: simultaneously applying the touch control scanning signal to all n columns of touch control drive electrodes in one group of touch control drive electrodes and receiving the sensing signals from all the touch control sensing electrodes; and
S2: repeating step S1 in sequence for each of the m groups of touch control drive electrodes until the touch control scanning operation has been performed for all the m groups of touch control drive electrodes.
